(19) United States
(12) Patent Application Publication
(10) Pub. No.: US 2007/0261242 A1
(43) Pub. Date: Nov. 15, 2007

(54) METHOD FOR MANUFACTURING PHASE CHANGE TYPE HEAT SINK

(75) Inventors: Wan-Lin Xia, Shenzhen (CN); Tao Li, Shenzhen (CN); Min-Qi Xiao, Shenzhen (CN)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: FOXCONN TECHNOLOGY CO., LTD., TU CHENG (TW)

(21) Appl. No.: 11/308,850

(22) Filed: May 15, 2006

(51) Int. Cl. B21D 53/02; B23P 15/26

(52) U.S. Cl. 29/890.03; 29/890.054

(57) ABSTRACT

A method for manufacturing a phase change type heat sink, includes following steps: (1) offering a workpiece as parent material and fixing it; (2) performing a cutting operation on an surface of the workpiece to form a cover integrated with a group of fins; (3) offering a tank with a cavity inside thereof and a quantity of working fluid contained in the cavity; (4) welding the cover and the tank together to seal the cavity to thereby achieve the phase change type heat sink.

### FIELD OF THE INVENTION

The present invention relates to a method for manufacturing a heat sink, and more particularly to a method for manufacturing a phase change type heat sink.

### DESCRIPTION OF RELATED ART

As computer technology continues to advance, electronic components such as central processing units (CPUs) of computers are being made to provide faster operational speeds and greater functional capabilities. When a CPU operates at a high speed in a computer enclosure, its temperature usually increases enormously. It is therefore desirable to dissipate the generated heat of the CPU quickly before damage is caused.

Conventionally, a heat sink is used to dissipate heat generated by a CPU. A conventional heat sink comprises a base contacting with the CPU and a plurality of fins attached to the base. The heat sink dissipates heat by conduction. However, as the heat generated by the CPU and other electronic devices continues to increase, the conventional heat sink can not meet its heat dissipating requirements any longer. Thus, phase change type heat sinks have gradually begun to replace the conventional heat sink.

A phase change type heat sink has an evacuated cavity and a quantity of working fluid sealed in the cavity. The phase change type heat sink transfers heat via phase transition of the working fluid. Thus, the phase change type heat sink has good heat conductivity and can quickly transfer heat from one place to another place.

Referring to FIG. 6, a conventional phase change type heat sink comprises a hermetically sealed container 10 having a quantity of water enclosed therein. The container 10 is vacuum-exhausted to form a vacuum thus making the water easy to evaporate. The container 10 comprises a base 12 for contacting the assembly with a heat-generating component such as a CPU, and a cover 14 facing the base 12 with a plurality of fins 20 attached thereto. In use, heat produced by the CPU is conducted to the base 12 and evaporates the water. The vapor flows towards the cover 14 and dissipates the heat thereto, then condenses into water and returns back to the base 12 to continue the cycle. The heat transferred to the cover 14 is radiated by the fins 20 to surrounding air.

The cover 14 and the fins 20 are usually connected via welding, as a result, an interface heat resistance is formed between the cover 14 and the fins 20, which degrades the heat conduction from the cover 14 to the fins 20. Furthermore, the high temperatures used in welding can damage the capillary structure and hermetical effectiveness of the phase change type heat sink. These possible damages can result in the functional reliability of the phase change type heat sink being weakened and the useful life of the phase change type heat sink being shortened.

### SUMMARY OF THE INVENTION

A method for manufacturing a phase change type heat sink, comprises the following steps: (1) offering a workpiece as parent material and fixing it; (2) performing a cutting (i.e., skiving) operation on an surface of the workpiece to form a cover integrated with a group of fins; (3) offering a tank with a cavity inside thereof and a quantity of working fluid and a capillary structure contained in the cavity; (4) welding the cover and the tank together to seal the cavity to thereby achieve a phase change type heat sink.

Other advantages and novel features will become more apparent from the following detailed description of preferred embodiments when taken in conjunction with the accompanying drawings, in which:

### BRIEF DESCRIPTION OF THE DRAWINGS

Many aspects of the present method can be better understood with reference to the following drawings. The components in the drawings are not necessarily drawn to scale, the emphasis instead being placed upon clearly illustrating the principles of the present method. Moreover, in the drawings, like reference numerals designate corresponding parts throughout the several views

FIG. 1 is a perspective view of a phase change type heat sink manufactured according to a method in accordance with a preferred embodiment of the present invention;

FIG. 2 an exploded view of the phase change type heat sink;

FIG. 3 shows a process of cutting operation on an upper surface of a plane workpiece;

FIG. 4 is a side view of the workpiece after the cutting operation;

FIG. 5 is an exploded view of another phase change type heat sink; and

FIG. 6 is a sectional view of a conventional phase change type heat sink.

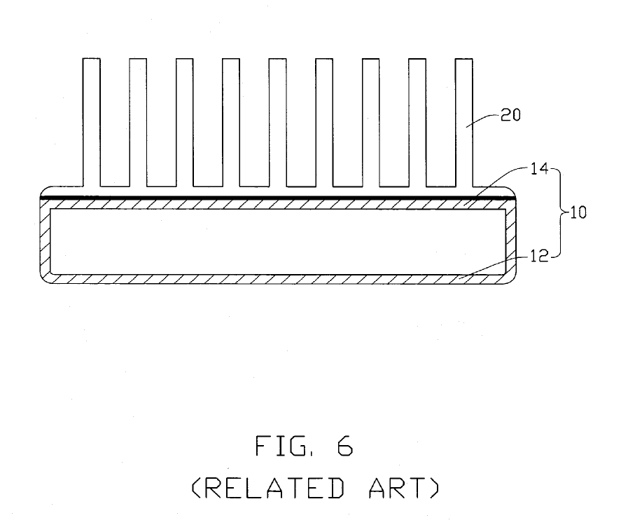

### DETAILED DESCRIPTION OF THE INVENTION

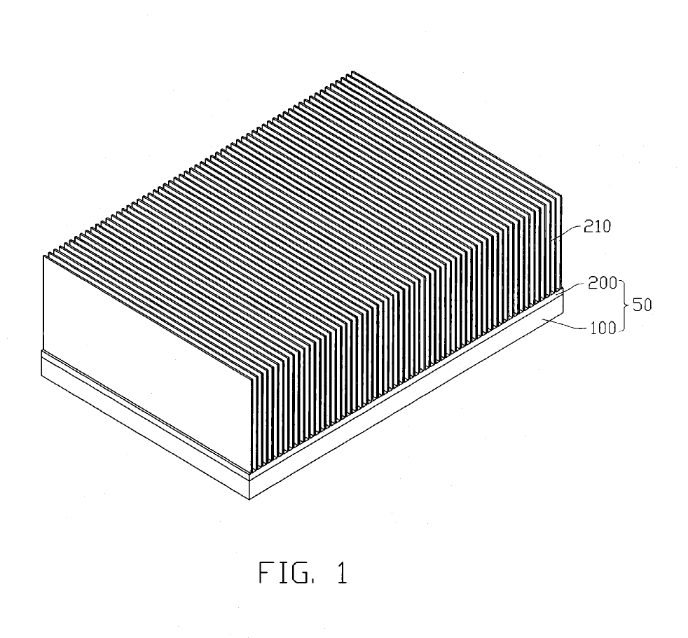

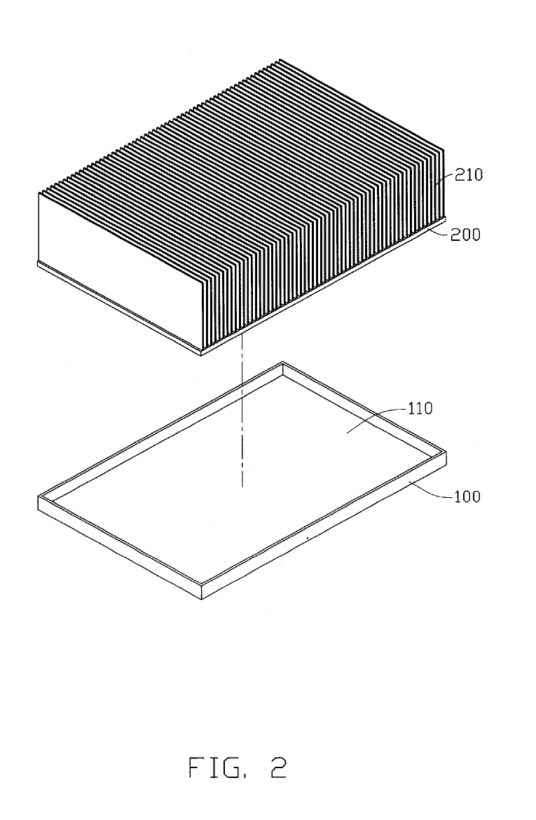

FIGS. 1-2 illustrate a phase change type heat sink 50 manufactured according to a method in accordance with a preferred embodiment of the present invention. The phase change type heat sink 50 comprises a tank 100 with a cavity 110 inside thereof, and a cover 200 with a plurality of fins 210 integrally formed thereon. The cover 200 is used for covering the tank 100 to thereby hermetically seal the cavity 110 of the tank 100. A quantity of working fluid (not shown) is contained in the cavity 110 for transferring heat from the tank 100 to the cover 200 via phase transition. The cavity 110 is evacuated for easily evaporating the working fluid. Additionally, a wick structure (not shown) such as sintering powder is formed on an inner surface of the cavity 110 for returning the working fluid back to a bottom portion of the tank 100 for another circulation.

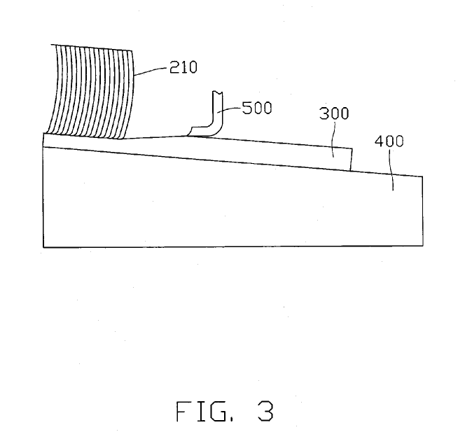

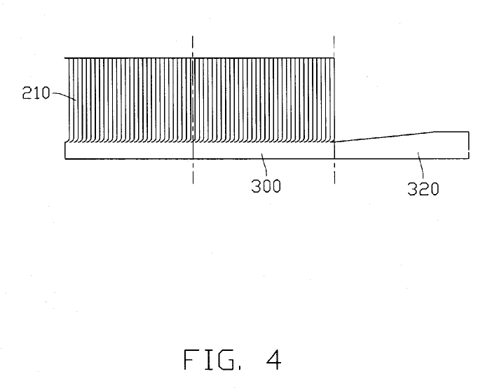

A method for manufacturing the phase change type heat sink 50 as described above comprises following steps as shown in FIG. 2-4.

Step (1) offering a plane workpiece 300 as parent material and fixing it on an upper surface of a fixture 400. The plane workpiece 300 is made of a heat conductive material such as copper or aluminum. Preferably, the upper surface of the plane workpiece 300 is horizontal for facilitating cutting (i.e., skiving) operation in the next step. The fixture 400 has a slanted surface (not labeled) to support the work piece 300.

Step (2) performing a cutting (i.e., skiving) operation on an upper surface of the plane workpiece 300 by using a wedge-shaped cutting tool 500 moving back and forth in a line on the upper surface of the plane workpiece 300 to form the fins 210; then cutting off an unprocessed portion of the workpiece 300, whereby the cover 200 with fins 210 integrally formed is finished. The fins 210 formed in this operation may be lightly curving, a straightening step may directly go after this step to straighten the fins 210 perpendicular to the unprocessed workpiece 300.

Step (3) offering a tank 100 with a cavity 110 inside thereof. A quantity of working fluid is contained in the cavity 110 and a wick structure is formed on an inner surface of the cavity 110.

Step (4) welding the cover 200 and the tank 100 together to seal the cavity 110 to thereby achieve a phase change type heat sink 50.

Additionally, the wick structure in the cavity 110 can be omitted; in this case, the condensed working fluid flows back to a bottom of the cavity 110 by gravity. In addition, after Step (4), a vacuuming operation is applied to the cavity 110 to pump out air therein so that the tank 100 is vacuumed.

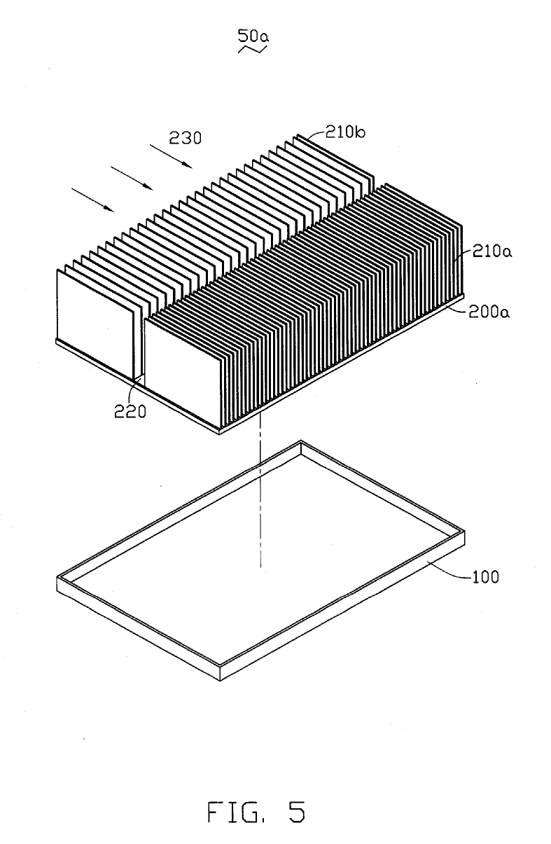

As shown in FIG. 1, there is only one group of parallel fins 210 directly extending from the upper surface of the cover 200. For one embodiment, there may be two or more groups of parallel fins directly extending from the upper surface of the cover 200. For example, another phase change type heat sink 50a is illustrated in FIG. 5. There are two spaced groups of parallel fins 210a, 210b directly extending from the upper surface of the cover 200a. A channel 220 defined between the two groups of parallel fin 210a, 210b separates the two groups of parallel fins 210a, 210b from each other. The channel 220 may be used to install a clip, which stretches across the channel 220 and mounts the phase change type heat sink 50a onto a top surface of a component to be cooled. Furthermore, the fins 210b are formed on the cover 220a at a predesigned interval different from that of the fins 210a, to cause a turbulent airflow in the fins 210b, 210a when an airflow 230 flows across the fins 210b, 210a.

The phase change type heat sink 50a can be manufactured in a quite similar method to that described above. The small difference is in step (2): after forming the fins 210a, the step (2) further comprises a step where the plane workpiece 300 is horizontally moved a predetermined distance relative to the cutting tool 500 to form the channel 220, then the cutting operation continues to form a neighboring group of fins 210b of the fins 210a. Furthermore, the cutting tool 500 and the feed rate control the thickness and the interval of adjacent fins 210a (or 210b).

The method utilizes the cutting (i.e., skiving) technology to cutting out a plurality of fins 210 (210a, 210b) on the upper surface of the plane workpiece 300 to form the cover 200 (200a). The fins 210 (210a, 210b) and the cover 200 (200a) are formed from a one-piece stock of the plane workpiece 300; thus, there is no interface heat resistance therebetween. The cutting technology has a fast processing capability and produces thin fins, which means that fin density of the fins 210 (210a, 210b) on the outer surface of the cover 200 (200a) can be increased. Furthermore, according to the preferred embodiment, the welding operation for mounting fins on a cover used in conventional method is avoided, whereby the possible damage to the cover 200 (200a) by the high temperature of the welding can be avoided in the preferred embodiment. Thus, the functional reliability of the phase change type heat sink 50 (50a) can be improved and the useful life of the phase change type heat sink 50 (50a) can be extended.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A method for manufacturing a phase change type heat sink, comprising following steps:
offering a workpiece as parent material and fixing it;
performing a cutting operation on a surface of the workpiece to form a cover with a group of integral fins;
offering a tank with a cavity inside thereof and a quantity of working fluid contained in the cavity; and
welding the cover and the tank together to seal the cavity to thereby achieve the phase change type heat sink.

2. The method as claimed in claim 1, wherein the cutting operation is using a cutting tool moving back and forth in a line on the surface of the workpiece to form the group of fins.

3. The method as claimed in claim 2, wherein the cutting operation further comprises a step where the workpiece is horizontally moved a predetermined space relative to the cutting tool to form a channel, then the cutting operation continues to form another group of fins adjacent to the group of fins.

4. The method as claimed in claim 3, wherein fins of the another group of fins are directly extending from the cover at an interval different form that of fins of the group of fins.

5. The method as claimed in claim 3, wherein the channel is used to install a clip, which stretches across the channel and mounts the phase change type heat sink on a component to be cooled.

6. The method as claimed in claim 2, further comprising a step directly goes after the cutting operation: cutting off an unprocessed portion of the workpiece.

7. The method as claimed in claim 2, further comprising a straightening step directly after the cutting operation to straighten the fins perpendicular to the unprocessed workpiece.

8. The method as claimed in claim 1, wherein a wick structure is formed on an inner surface of the cavity.

9. The method as claimed in claim 1, wherein the workpiece is fixed on a fixer, which has a slanted surface to support the workpiece.

10. The method as claimed in claim 1, further comprising a step after the welding step: pumping air out of the cavity to make the tank be vacuum-exhausted.

11. A method for manufacturing a heat sink comprising:
preparing a plate integrally formed with a plurality of fins on a top surface thereof;
preparing a tank having a cavity, a wick structure and working fluid inside the cavity;
soldering the plate to the tank to hermetically seal the cavity, wherein the fins extend in a direction away from the cavity; and
pumping air in the cavity out of the cavity.

12. The method as claimed in claim 11, wherein the fins are integrally formed on the plate by skiving the plate.

13. The method as claim in claim 12, wherein the fins are divided into two groups, fins of one of the groups having a fins density different from that of the other of the groups.

14. The method as claimed in claim 13, wherein a channel is located between the two groups of fins adapted for receiving a clip.

15. The method as claim in claim 11, wherein the fins are divided into two groups, the fins of one of the groups having a fins density different from that of the other of the groups.

16. The method as claimed in claim 15, wherein a channel is located between the two groups of fins adapted for receiving a clip.
